(19) United States
(12) Patent Application Publication
(10) Pub. No.: US 2025/0127139 A1
(43) Pub. Date: Apr. 24, 2025

(54) CAT LITTER AND PREPARATION METHOD THEREOF

(71) Applicant: ShenZhen YUTO Packaging Technology Co., Ltd., Shenzhen (CN)

(72) Inventors: Yanfei CHENG, Shenzhen City (CN); Zhengyang MU, Shenzhen City (CN); Guocheng HAN, Shenzhen City (CN); Wei HE, Shenzhen City (CN); Yao PENG, Shenzhen City (CN)

(73) Assignee: ShenZhen YUTO Packaging Technology Co., Ltd., Shenzhen (CN)

(21) Appl. No.: 18/389,742

(22) Filed: Dec. 19, 2023

(30) Foreign Application Priority Data
Oct. 18, 2023 (CN) 202311359389.4

(51) Int. Cl. A01K 1/015

(52) U.S. Cl. CPC A01K 1/0155; A01K 1/0154

(57) ABSTRACT

A cat litter and its preparation method are provided. The cat litter has a core-shell structure, including: a core, including following components by mass parts: non-grain plant fibers in 100 parts, clumping agents in a range of 0.6-12 parts, water-absorbing agents in a range of 0.6-12 parts, breeding improvement agents in a range of 0.13-2.23 parts, deodorizing agents in a range of 0.13-2.23 parts, and anti-mold agents in a range of 0.13-2.23 parts; and a shell layer, including following components by mass parts: non-grain plant fibers in 100 parts, clumping agents in a range of 99.5-600 parts, water-absorbing agents in a range of 3.33-100 parts, breeding improvement agents in a range of 33.3-300 parts, deodorizing agents in a range of 3.33-100 parts, and anti-mold agents in a range of 0.66-20 parts. Furthermore, a mass ratio of the shell layer to the core is 1:(4-5).

### CROSS-REFERENCE TO RELATED DISCLOSURES

This application is based upon and claims the benefit of priority of the Chinese Application No. 202311359389.4, filed on Oct. 18, 2023, the disclosure of which is hereby incorporated by reference in its entirety for all purposes.

### TECHNICAL FIELD

This disclosure relates to the technical field of pet cleaning supplies, specifically relating to a type of cat litter and its preparation method.

### BACKGROUND

To facilitate cat owners in timely cleaning cat excrement and to free their hands, avoiding the strong odor released during manual scooping, cat litter has appeared in the market. Cat litter is used by pet owners for their cats to bury feces and urine, generally having good water absorption capability. Cat litters are divided into organic and inorganic types based on chemical properties and materials. Organic cat litters include paper and pea dregs litter, while inorganic cat litters include bentonite and crystal cat litter.

Paper cat litter has weaker water absorption effect and clumping force. Pea dregs cat litter contains components like proteins and fats from pea and soybean dregs, which can decay and produce odors in high humidity, thus failing to deodorize and instead becoming a source of bad smell. Bentonite cat litter's main drawback is dust, which can cause urinary and respiratory infections in cats if not handled carefully. Crystal cat litter does not clump easily, has large particles, is uncomfortable, and is inconvenient to use, not being flushable in toilets.

### SUMMARY

The present disclosure provides a type of cat litter and its preparation method, aiming to offer a pet bedding material that is easy to absorb water, has good clumping ability, is dust-free and water-soluble, has antibacterial and deodorizing functions, and can adapt to various smart cat toilets.

According to a first aspect of the present disclosure, a cat litter having a core-shell structure is provided. The cat litter includes:
a core, including following components by mass parts: non-grain plant fibers in 100 parts, clumping agents in a range of 0.6-12 parts, water-absorbing agents in a range of 0.6-12 parts, breeding improvement agents in a range of 0.13-2.23 parts, deodorizing agents in a range of 0.13-2.23 parts, and anti-mold agents in a range of 0.13-2.23 parts; and
a shell layer, including following components by mass parts: non-grain plant fibers in 100 parts, clumping agents in a range of 99.5-600 parts, water-absorbing agents in a range of 3.33-100 parts, breeding improvement agents in a range of 33.3-300 parts, deodorizing agents in a range of 3.33-100 parts, and anti-mold agents in a range of 0.66-20 parts;
where mass ratio of the shell layer to the core is 1:(4-5).

According to a second aspect of the present disclosure, a method for preparing a cat litter is provided. The method may include the following steps:
providing a first raw material for a core of the cat litter, comprising following components by mass parts: components of the core according to the first aspect, and water in a range of 120-1000 parts;
providing a second raw material for the shell layer, comprising following components by mass parts: components of the shell layer according to the first aspect, and water in a range of 133-1000 parts;
mixing and first stirring the first raw material to obtain a first mixture;
granulating and first sieving the first mixture to obtain an intermediate product of the core;
mixing and second stirring the second raw material to obtain a shell layer mixture;
wetting the intermediate product of the core, and then wrapping the intermediate product of the core with the shell layer mixture to obtain a coated mixture; and
third sieving and drying the coated mixture to obtain the cat litter.

### BRIEF DESCRIPTION OF DRAWINGS

To clarify the technical solutions of the disclosure more clearly, the following provides a brief introduction to the figures used to illustrate the examples of this disclosure. For those of ordinary skill in the art, other drawings can be obtained based on these illustrations without creative effort.

FIG. 1 shows the actual product image of the cat litter in accordance with some examples of the present disclosure.

FIG. 2 is a flow chart illustrating a method for cat litter preparation in accordance with some examples of the present disclosure.

### DETAILED DESCRIPTION

To further explain and clarify the objectives, technical solutions, and beneficial technical effects of this disclosure, the following describes the disclosure in further details in conjunction with examples. It should be understood that examples described in this specification are merely for explaining this disclosure and are not intended to limit this disclosure.

For convenience, this disclosure has only explicitly disclosed some numerical ranges. However, any lower limit can be combined with any upper limit to form a range not explicitly recorded, and any lower limit can be combined with other lower limits to form a range not explicitly recorded, similarly any upper limit can be combined with any other upper limit to form a range not explicitly recorded. In addition, although not explicitly recorded, each point or individual value between the range endpoints is included within the range. Therefore, each point or single value can serve as its own lower or upper limit and be combined with any other point or single value or with other lower or upper limits to form a range not explicitly recorded.

In the description of this disclosure, it should be noted that, unless otherwise specified, the range “above” a number or “below” a number includes the number, and the word “more” in “one or more” means two or more. In the description of this disclosure, “sieve” and “screen” are used interchangeably to refer to an equipment for performing an act of sieving or screening.

The aforementioned content of this disclosure is not intended to describe every publicly disclosed example or every type of example in this disclosure. The following description more specifically illustrates exemplary examples. Throughout the disclosure, guidance is provided through a series of examples that can be used in various combinations. In each example, enumeration serves only as representation and should not be interpreted as exhaustive.

In the process of rotating a built-in grid in a smart cat litter box to clean cat waste, the cat litter particle aggregates will flow as the grid rotates. The reason for the flow of the particle aggregates is due to the imbalance of forces on the particles. An analysis of the forces on the particles reveals that during the flow, the forces involved include gravity, adhesive force between particles, friction, and static electricity, among which gravity and the adhesive force between particles have the most significant impact on the flow.

The agents affecting the flowability of cat litter particles are complex. Research has found that the particle size distribution, shape, and sphericity of the cat litter particles have a significant impact on flowability. In addition, moisture content, static voltage, porosity, bulk density, and internal friction coefficient also affect the flowability of the particles. Analyzing the agents affecting particle flowability is of great significance for adopting scientific methods to improve the flowability of particle aggregates.

This disclosure provides a type of cat litter, which includes a core and a shell layer. The components and their mass ratio of the core and shell layer affect the flowability of the cat litter, making the cat litter in this disclosure freely adaptable to various smart litter boxes on the market, aiming for universality. This achieves the goal of separating clean cat litter from clumped urine litter and wrapped feces, avoiding waste of unused cat litter, making it less likely for clumps of waste to remain in the clean litter, and reducing odor residue.

### Cat Litter

In a first aspect: the present disclosure provides a cat litter having a core-shell structure, including: a core, including following components by mass parts: non-grain plant fibers (100 parts), clumping agents (0.6-12 parts), water-absorbing agents (0.6-12 parts), breeding improvement agents (0.13-2.23 parts), deodorizing agents (0.13-2.23 parts), and anti-mold agents (0.13-2.23 parts); and a shell layer, including following components by mass parts: non-grain plant fibers (100 parts by mass), clumping agents (99.5-600 parts), water-absorbing agents (3.33-100 parts), breeding improvement agents (33.3-300 parts), deodorizing agents (3.33-100 parts), and anti-mold agents (0.66-20 parts); where mass ratio of the shell layer to the core is 1:(4-5).

According to an example of this disclosure, the cat litter provided by this disclosure uses a differentiated design for the core and shell layer, where the shell layer has a suitable mass part of clumping agents, beneficial for clumping during the preparation of the cat litter; when the cat litter is used, the clumping agent of the above-mentioned mass parts in the shell layer, under the action of the above-mentioned mass parts absorption agent, helps the cat litter to absorb moisture from cat urine and feces, thus clumping and preventing pollution of other cat litter; when the water absorption agent in the shell layer absorbs moisture from cat urine and feces, the appropriate mass parts of non-grain plant fibers and water absorption agents in the core layer act together to help retain the absorbed moisture; by choosing the appropriate mass ratio of the shell layer to the core, a pet pad material is prepared using the cat litter provided by present disclosure, which has water absorption, clumping, antibacterial and deodorizing functions and is adaptable to various types of smart cat litter boxes.

The shell layer in the cat litter has a strong water absorption and water-condensing function, providing the cat litter with excellent water absorption performance, preventing cat urine from quickly leaking to the bottom of the litter pan, which is inconvenient to clean, and also provides the cat litter with good rapid clumping ability and excellent clumping drop strength.

The core of the cat litter, through the selection of raw materials, moisture content control, and weight modification, gives the core a higher hardness. The core and the shell layer have an appropriate mass ratio, providing the cat litter with a higher main body hardness, main body specific gravity, and excellent shape support.

The cat litter of this disclosure, with plant fibers as the main raw material, has the characteristics of being dust-free, safe and pollution-free, biodegradable, made from natural and renewable raw materials, rapid water absorption, strong clumping, deodorizing, and universality for various smart cat litter boxes.

The cat litter of this disclosure has the functions of water absorption, clumping, antibacterial deodorization, and can be adapted to various types of smart cat litter boxes.” In some alternative examples, the sphericity of the cat litter satisfies the following: the cumulative distribution rate of particles with a roundness value greater than or equal to 0.7 is greater than or equal to 88%; the cumulative distribution rate of particles with a roundness value less than or equal to 0.3 is less than or equal to 1.5%. By controlling the sphericity of the cat litter, the friction and adhesion between particles are reduced, thereby improving the flowability index of the cat litter particles, making the probability of particle bridging virtually zero. Through multi-stage and multiple screenings, the dust content of cat litter is strictly controlled, eliminating the stickiness during the particle flow process caused by fine dust, and thereby improving the flowability index of the cat litter particles.

The analysis of the relationship between different particle shapes, sizes, and the flowability of the particles is discussed here. Spherical particles have the smallest contact area with each other, thus having the best flowability. The flowability of cubic particles is next, followed by particles of other irregular shapes. Flaky, dendritic, and needle-shaped particles have a large number of planar contact points and shear forces between irregular particles, resulting in poor flowability.

According to the examples of this disclosure, the mass ratio of the shell layer to the core is within the above-recited range, controlling the bulk density of the cat litter within a suitable range, which solves the problem of poor flowability and low grid passability during the rotation and cleaning of cat excrement in smart cat toilets due to the light and low specific gravity characteristics of cat litter that cause it to slide from the bottom of the litter box in the direction of rotation using appropriate density.

In some alternative examples, a bulk density of the cat litter is 280-400 g/L.

According to examples of this disclosure, compared to tofu cat litter which has a bulk density of about 500-600 g/L, the bulk density of a tofu/bentonite mixed cat litter is about 700-800 g/L, and the bulk density of bentonite cat litter can reach up to 1000 g/L, while the plant fiber cat litter of this invention only has a bulk density of 280-400 g/L. The lightweight and low specific gravity characteristics of this disclosure facilitate the stockpiling, handling, and replacement of cat litter.

In some alternative examples, a moisture content of the cat litter is 5%-10%.

According to the examples of this disclosure, having the moisture content of the cat litter within the aforementioned range can, on one hand, improve the comfort when the cat litter comes into contact with the cat, and on the other hand, improve the clumping properties of the various components in the cat litter. It has a certain amount of water absorption capacity, which is convenient for absorbing the moisture in the cat feces to achieve clumping. In addition, having the moisture content within the above range reduces the static electricity caused by the excessive dryness of the finished cat litter particles, which leads to mutual attraction and adhesion between particles, and improves the flowability index of the cat litter particles. This enhances the flowability of the cat litter and the pass-through of unclumped clean cat litter in the grid holes during the turning and cleaning process of the smart cat toilet.

In some alternative examples, the cat litter is configured to be sifted through a 10-mesh sieve. Alternatively, the cat litter can pass through sieves of various mesh sizes including 10, 20, 30, 40, or 50 mesh, or any range composed thereof.

The cat litter that is configured to be sifted through a 10-mesh sieve means that the pore size of a 10-mesh sieve is usually about 2.00 to 3.5 millimeters. A 20-mesh sieve typically has a pore size of about 1.00 millimeter. Cat litter that can pass through a 20-mesh and a 25-mesh sieve can necessarily also pass through sieves with larger pore sizes like 10-mesh. Cat litter configured to be sifted through a 10-mesh sieve is appropriate for use with smart cat toilets, fitting through the gaps between the grates.

According to examples of this disclosure, cat litter that is configured to be sifted through a 10-mesh sieve meets the above conditions and can improve the flowability of non-grain plant fibers in the cat litter by enhancing the raw materials and molding process at various stages of cat litter formation. This allows unclumped clean cat litter to be retained in the hollow spaces of the grid plate in the smart cat toilet, avoiding waste of unused cat litter. The clumped cat litter containing feces can be directly discharged, which can be directly flushed down toilets or drains, with good flowability and without causing clogging.

In some alternative examples, a ratio of dust of the cat litter is at most 0.05%.

According to examples of this disclosure, having the dust ratio of the cat litter within the above range is beneficial for providing cats with a clean and comfortable environment. It reduces the impact of dust on the cat's urinary and respiratory systems, which is beneficial for the cat's health.

In some alternative examples, a bulk density of the cat litter is 280-400 g/L.

Bulk density refers to the density of a pile of particulate or powdered material under specific conditions. It is usually expressed as the ratio of mass to volume, and the units are typically grams per cubic centimeter (g/cm³) or kilograms per cubic meter (kg/m³).

In some alternative examples, the cat litter is in a rod-shape, and the core is in the rod-shape; where the rod-shape has a diameter of 2-3.5 mm and a length-to-diameter ratio of (1-3):1; a thickness of the shell layer is 0.5-3 mm.

According to examples of this disclosure, when the cat litter is in a rod-shape, and the core is in the rod-shape; where the rod-shape has a diameter of 2-3.5 mm and a length-to-diameter ratio of (1-3):1, a thickness of the shell layer is 0.5-3 mm, the described shape, the ratio of the rod's length to its diameter, and the thickness of the shell layer make the cat litter be adapted to smart cat toilets. This allows for complete separation of urine-clumped cat litter and feces-wrapped cat litter from unused clean cat litter, preventing the waste of unused clean cat litter.

According to examples of the disclosure, by controlling the particle size and shape of the cat litter through equipment, the sphericity of the cat litter particles is improved. The cat litter is consolidated by wrapping the core with the shell layer, so as to achieve a better bond between the core and the shell layer, improve the uniformity of the cat litter particle shape and size, which also enhances the sphericity of the cat litter particles, contributing to an increased flowability index for the cat litter particles.

According to examples of the disclosure, the granularity, morphology, inter-particle interactions, and hygroscopicity of the cat litter affect its flowability. The control over the particle size and size distribution of the cat litter aimed at the dimensions of the hollowed-out cells on the grid of the smart cat toilet allows the cat litter of this disclosure to freely adapt to various types of smart cat toilets on the market. The cat litter is universally compatible through the smart cat toilet, achieving the goal of clean separation between urine-clumped and feces-wrapped cat litter and unclumped clean cat litter. This prevents waste of unused cat litter and ensures that the clumped portions of the cat waste do not remain in the clean litter, thus avoiding residual odor.

As an example of this disclosure, the cat litter includes: a core, including following components by mass parts: non-grain plant fiber:100 parts, clumping agents:0.6˜8 parts, water absorption agents:0.6˜8 parts, breeding improvement agents:0.13˜1.23 parts, deodorization agents:0.13˜2.23 parts, anti-mold agents:0.13˜2.23 parts; and a shell layer, covering the core, the shell layer by mass parts including following components: non-grain plant fiber:100 parts, clumping agents:99.5˜400 parts, water absorption agents:3.33˜100 parts, breeding improvement agents:33.3˜300 parts, deodorization agents:3.33˜100 parts, anti-mold agents:0.66˜20 parts;

where the non-grain plant fiber includes one or several of sugarcane bagasse fiber, bamboo fiber, corn cob fiber, and eucalyptus fiber; the clumping agents include one or several of sodium carboxymethyl cellulose, guar gum, native starch, and pregelatinized starch; a mass ratio of the shell layer to the core is 1:(4˜5), a moisture content of the cat litter is 5%˜10%; the cat litter is configured to pass through a 10-mesh sieve; a bulk density of the cat litter is 280-400 g/L; the cat litter is in a rod-shape, the core is in the rod-shape, where the rod-shape has a diameter of 2-3.5 mm and a length-to-diameter ratio of (1-3):1; a thickness of the shell layer is 0.5 mm˜3 mm. A ratio of dust of the cat litter ≤0.05%, a flow index of the cat litter is 85-95, a clumping weight of the cat litter is 25-30 grams per 20 grams of water; a clumping strength of the cat litter is 90%-98%, a water absorption rate of the cat litter is 200%-300%, and an onset of mold growth in the cat litter is more than 30 days.

As another example of this disclosure, the cat litter includes: a core, which by mass parts includes following components: non-grain plant fiber:100 parts, clumping agents:0.6˜10 parts, water absorption agents:0.6˜10 parts, breeding improvement agents:0.13˜2.23 parts, deodorization agents:0.1˜2.23 parts, anti-mold agents:0.13˜2.23 parts; and a shell layer, covering the core, the shell layer by mass parts includes the following components: non-grain plant fiber: 100 parts, clumping agents:99.5˜100 parts, water absorption agents:50˜100 parts, breeding improvement agents:33.3˜300 parts, deodorization agents:3.33˜100 parts, anti-mold agents: 0.66˜20 parts;

Where the non-grain plant fiber includes one or several of sugarcane bagasse fiber, bamboo fiber, corn cob fiber, and eucalyptus fiber; the clumping agents includes one or several of sodium carboxymethyl cellulose, guar gum, native starch, and pregelatinized starch; the mass ratio of the shell layer to the core is 1:(4˜5), a moisture content of the cat litter is 5%˜10%; the cat litter is configured to pass through a 10-mesh sieve; a bulk density of the cat litter is 280-400 g/L; the cat litter is in a rod-shape, the core is in the rod-shape, where the rod-shape has a diameter of 2˜3.5 mm and a length-to-diameter ratio of (1-3):1; a thickness of the shell layer is 0.5 mm˜3 mm. A ratio of dust of the cat litter ≤0.05%, a flow index of the cat litter is 85-95, a clumping weight of the cat litter is 25-30 grams per 20 grams of water; a clumping strength of the cat litter is 90%-98%, a water absorption rate of the cat litter is 220%-250%, and an onset of mold growth in the cat litter is more than 30 days.

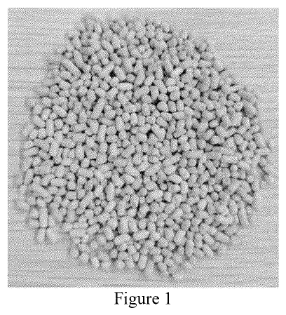

As an example, the physical appearance of the cat litter is shown in FIG. 1.

In some alternative examples, the non-grain plant fibers include one or more of following fibers: sugarcane bagasse fiber, bamboo fiber, corn cob fiber, eucalyptus fiber, giant fungus fiber, straw fiber, dragon beard grass fiber, and bamboo shoot shell fiber.

According to examples of this disclosure, fibers such as bamboo fiber, corn cob powder, eucalyptus powder, and other aforementioned fibers, which are hard, elastic, sturdy, and dense plant fiber powders, are used as the main material for the core support part of the cat litter molding. This provides the cat litter with high body hardness and excellent shape support, facilitating further control of the shape and size of the cat litter particles, as well as the development of post-processing steps such as coating the core with a shell layer and polishing. This improves the uniformity of the shape and size of the cat litter particles, increases the flowability index and sphericity of the cat litter particles, and enhances the high flowability of the unclumped clean cat litter and the passage rate through the hollow grid of the smart cat toilet.

According to examples of this disclosure, the non-grain plant fibers are derived from natural plant fibers from agricultural and forestry operations, belonging to non-grain renewable resources, environmentally friendly and sustainable; the raw material sources are unrestricted, and the supply of natural, renewable non-grain plant fiber resources is abundant.

In some alternative examples, a granular diameter of the non-grain plant fibers configures the cat litter to pass through an 80˜100 mesh screen.

According to examples of this disclosure, by controlling the granular diameter of the non-grain plant fibers in the cat litter within the aforementioned range, the water solubility of the cat litter is improved, facilitating its disposal through indoor plumbing such as toilets, providing convenience for pet owners.

In some alternative examples, the clumping agents include one or more of following agents: whey protein, sodium alginate, corn protein, montmorillonite, carboxymethyl cellulose and its derivatives, guar gum, native starch, pre-gelatinized starch, or gelatin.

According to examples of this disclosure, the aforementioned clumping agents can enhance the cohesion between non-grain plant fibers as well as between non-grain plant fibers and other components. These clumping agents can improve the clumping of cat litter with other cat litter, cat litter with cat feces, and other feces, facilitating the encapsulation of cat feces, and reducing contamination of other cat litter.

In some alternative examples, the water-absorbing agents include one or more of following agents: polyacrylate, starch-acrylate polymer, starch-acrylonitrile graft copolymer, acrylamide-acrylonitrile-acrylic acid terpolymer, polyacrylamide and its derivatives, or polyvinyl alcohol.

According to examples of this disclosure, the water-absorbing agents, in combination with non-grain plant fibers, can on one hand absorb moisture in cat feces, reducing contamination of other cat litter, and on the other hand, the interaction of non-grain plant fibers with water-absorbing agents provides certain water absorption and water retention properties, reducing the seepage of moisture adsorbed in cat feces, thereby lowering contamination to other cat litter. In some alternative examples, cultivation improvement agents include one or more of following agents: attapulgite, polyacrylamide-attapulgite composite adsorbents, high purity nanomodified montmorillonite, essential oils, hydrated sodium aluminosilicate, diatomaceous earth, or zeolite.

According to examples of this disclosure, using cultivation improvement agents, the core layer of the plant fiber cat litter has been modified to increase weight, which improves the flow index of cat litter after weight-increasing modification, making it easier to pass through the grid of the cat toilet, preventing cat litter waste.

In some alternative examples, deodorizing agents include one or more of following agents: allophane, hydrophilic modified ultrafine silica, baking soda, nano zinc oxide, or nano titanium dioxide.

In some alternative examples, anti-mold agents include one or more of following agents: esterified glucomannan, hydrated calcium sodium aluminosilicate, silver-loaded zirconium phosphate antibacterial powder, copper-loaded phosphate antibacterial powder, organic zinc ion antibacterial powder, 5-chloro-2-methyl-4-isothiazolin-3-one, 12-benzisothiazolin-3-one, 45-dichloro-2-octyl-3-isothiazolinone, 2-methyl-4-isothiazolin-3-one, or N-octyl-4-isothiazolin-3-one.

### Method of Preparing The Cat Litter

Secondly, this disclosure provides a method for preparing the cat litter described earlier. The method includes:

providing a first material for the core, the first material including following components by mass parts: non-grain plant fibers (100 parts), clumping agents (0.6-12 parts), water-absorbing agents (0.6-12 parts), breeding improvement agents (0.13-2.23 parts), deodorizing agents (0.13-2.23 parts), and anti-mold agents (0.13-2.23 parts);

providing a second material for the shell layer, the second material including following components by mass parts: non-grain plant fibers (100 parts by mass), clumping agents (99.5-600 parts), water-absorbing agents (3.33-100 parts), breeding improvement agents (33.3-300 parts), deodorizing agents (3.33-100 parts), and anti-mold agents (0.66-20 parts);
mixing and first stirring the first raw material to obtain a first mixture;
granulating and first sieving the first mixture to obtain an intermediate product of the core;
mixing and second stirring the second raw material to obtain a shell layer mixture;
wetting the intermediate product of the core, and then wrapping the intermediate product of the core with the shell layer mixture to obtain a coated mixture; and
successively second sieving, drying, and third sieving the coated mixture to obtain the cat litter.

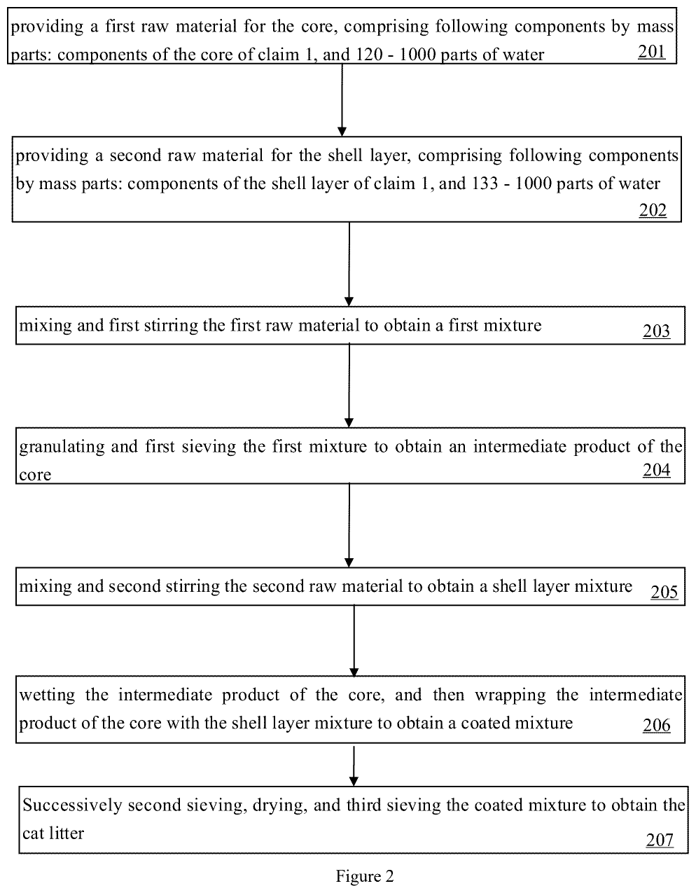

FIG. 2 is a flowchart illustrating a method for preparing the cat litter as illustrated in FIG. 1.

In Step 201, a preparer provides providing a first material for the core, the first material including following components by mass parts: non-grain plant fibers (100 parts), clumping agents (0.6-12 parts), water-absorbing agents (0.6-12 parts), breeding improvement agents (0.13-2.23 parts), deodorizing agents (0.13-2.23 parts), anti-mold agents (0.13-2.23 parts), and 120-1000 parts of water.

In Step 202, the preparer provides a second material for the shell layer, the second material including following components by mass parts: non-grain plant fibers (100 parts by mass), clumping agents (99.5-600 parts), water-absorbing agents (3.33-100 parts), breeding improvement agents (33.3-300 parts), deodorizing agents (3.33-100 parts), anti-mold agents (0.66-20 parts, and 133-1000 parts of water.

In Step 203, the preparer mixes and first stirs the first raw material to obtain a first mixture.

In Step 204, the preparer granulates and first sieves the first mixture to obtain an intermediate product of the core.

In Step 205, the preparer mixes and second stirs the second raw material to obtain a shell layer mixture.

In Step 206, the preparer wets the intermediate product of the core, and then wraps the intermediate product of the core with the shell layer mixture to obtain a coated mixture.

In Step 207, the preparer successively second sieves, dries, and third sieves the coated mixture to obtain the cat litter.

According to examples of this disclosure, a two-step method of granulation and mixing of the outer layer coating material is used. This reduces issues of loose appearance, low integrity, and high fragment content in the cat litter. The granulated core particles are wetted and coated with a special plant coating equipment to solidify the shell layer. This process produces cat litter with a compact appearance, high integrity, and fewer fragments, improving uniformity in shape and size, and enhancing the flow index of the cat litter particles.

In some alternative examples, a rotational speed for the first stirring is 5˜850 r/min, and a time for the first stirring is 0.5˜5 minutes.

In some alternative examples, a rotational speed for granulation is 800˜1000 r/min.

In some alternative examples, a rotational speed for the second stirring is 0˜1500 r/min, and a time is 0.5˜3 minutes. Alternatively, the rotational speed for the second stirring is 5-1000 r/min.

In some alternative examples, before providing the first material for the core or the second material for shell layer, the method further includes: crushing, mesh using plant fiber crushing equipment, non-grain plant fiber raw materials of the cat litter core particles to a fineness of 200˜ 400 mesh.

In some alternative examples, mixing and first stirring the first raw material to obtain a first mixture include:
using stirring and mixing equipment to uniformly mix non-grain plant fibers in the first raw material, with a rotational speed for stirring of 0˜850 r/min and a time for stirring of 0.5˜3 minutes;
adding water to the non-grain plant fibers by mass ratio, where water is added while stirring, and continuing to stir after the water is added. A rotational speed for stirring is 0˜850 r/min, with a total time for stirring of 0.5˜3 minutes. After the mixing is complete, set aside for later use to obtain a first raw material mixture;
using stirring and mixing equipment to mix clumping agents, water absorption agents, breeding improvement agents, deodorizing agents, and anti-mildew agents in the aforementioned mass ratio to blend evenly, with a rotational speed for stirring of 0˜1500 r/min and a time for stirring of 0.5˜3 minutes, to obtain a second raw material mixture;
mixing and stirring the first second raw material mixture and the second raw material mixture at a rotational speed for stirring of 0˜850 r/min for a total time for stirring of 0.5˜5 minutes to obtain the first mixture.

In some alternative examples, granulating and first sieving the first mixture to obtain an intermediate product of the core include:
granulating the first mixture using granulation equipment, where the granulation equipment's mold hole diameter ranges from 2 mm to 3.5 mm, hole length ranges from 8 mm to 20 mm, and the compression ratio of the mold is from 1.5 to 9. The mold hole ends are trumpet-shaped release ports with a vertical depth of 1 mm and a 60° angle between the arc surface tangent and the mold plane; where the granulation equipment's cutter is set horizontally, with a blade distance of 0.1˜0.5 mm from the mold plane, controlling the diameter of the extruded cat litter pellet core to be 2˜3.5 mm, with a length-to-diameter ratio of (1˜3):1. The equipment operates at a rotational speed of 800˜1000 r/min, followed by the first sieving to obtain the intermediate product of the core.

In some examples, the first sieving includes: sieving the intermediate kernel product obtained from the core press along with the debris and powder generated during the pressing process using an 8-mesh screen. After sieving, the particles will enter the wetting and plant coating process; screening can remove debris and powder, thus not wasting plant coating materials and reducing the generation of debris particles during the coating process.

In some alternative examples, the intermediate product of core is rod-shaped, a diameter of the intermediate product of core is 2-3.5 mm, and a length-to-diameter ratio of the intermediate product of core is (1-3):1.

In some alternative examples, a rotational speed of equipment during coating is 30˜60 r/min, and a time for coating is 2˜6 minutes.

In some alternative examples, a moisture content of the intermediate product of core is within 45%.

In some alternative examples, a moisture content of the shell layer mixture is within 50%. In some alternative examples, a moisture content of the coated mixture is within 45%.

According to examples of this disclosure, the moisture content is strictly controlled at appropriate levels throughout the cat litter formation process. This ensures the formation of cat litter while enhancing its hardness. It reduces the electrostatic effects caused by drying during the preparation and use of the cat litter, which leads to mutual attraction and adhesion between particles, thereby improving the flow index.

The moisture content control of each semi-finished and finished product includes controlling the moisture content of the compressed cat litter core to be within 45%, the moisture content of the wet cat litter after the shell layer wrapping to be within 45%, and the moisture content of the cat litter after the shell layer is wrapped and dried to be between 5% and 10%.

In some alternative examples, a 5-mesh filter screen is used to wrap the mixture for a second sieving. The wrapped mixture can be understood as large particles formed due to particle adhesion during the coating stage of the core because of the wet wrapping process. After the coating is completed, a 5-mesh filter screen is used to screen all the wrapped particles. Particles larger than 5-mesh after wrapping are retained for drying, while those smaller than 5-mesh are screened out and transferred to the core compression granulation stage.

In some alternative examples, multiple screenings are included after polishing and shaping.

According to examples of this disclosure, there is a problem of a large amount of powder falling off from particles larger than 5-mesh after drying, polishing, and shaping. After the polishing and shaping are completed, an 8-12 mesh filter screen is used for multiple screenings of all the particles formed after polishing and shaping. Particles smaller than the target size are all stored, and powder particles larger than 1 but smaller than the target size are screened out and transferred to the core compression granulation stage, with their ratio of dust controlled within 0.05%.

Furthermore, the multiple screenings in this disclosure can be multi-stage screenings of different particle sizes, or multiple screenings of the same particle size. The multiple screening process strictly controls the large-sized particles and ratio of dust in the finished cat litter, eliminating stickiness caused by fine dust during the flow of cat litter, thereby increasing the flow index of the cat litter particles.

In some alternative examples, mixing and second stirring the second raw material to obtain a shell layer mixture include:
crushing the non-grain plant fiber raw materials in the second raw material to a fineness of 80˜ 100 mesh;
using mixing equipment to mix the non-grain plant fibers in the second raw material with clumping agents, water-absorbing agents, breeding improvement agents, deodorizing agents, and anti-mold agents in the aforementioned proportions to form a uniform mixture. A rotational speed for mixing is 0˜1500 r/min, and a time/duration for mixing is 0.5˜3 minutes, resulting in the shell layer mixture.

In some alternative examples, wrapping the wet-treated intermediate product of the core with the shell layer mixture to obtain a coated mixture includes:

Introducing the shell layer mixture into the wet-treated intermediate product of the core using a wrapping device, alternatively rotating while introducing, with a device rotation speed of 30 60 r/min, wrapping time 2-6 minutes, and the wetted shell layer thickness being more than 0.5 mm.

In some alternative examples, wetting the intermediate product of the core includes: wetting the intermediate product of the core in the rotating device using a spraying treatment, with the device rotation speed being 30-60 r/min.

In some alternative examples, the wet-treated intermediate product of the core is wrapped with the shell layer mixture to obtain a coated mixture;

The coated mixture is sequentially/successively subjected to second sieving, drying, and third sieving the coated mixture to obtain the cat litter.

In some alternative examples, a granular diameter m of a product after the second sieving is:5 mesh <m<8 mesh.

In some alternative examples, a granular diameter n of a product after the third sieving is: 8 mesh <n<12 mesh, alternatively 10 mesh.

In some alternative examples, a temperature for drying is 65-75° C.

In some alternative examples, after drying, the method further includes polishing and shaping a dried product, where a rotational speed for polishing is 30-60 r/min, and a time for polishing is 15-30 minutes.

According to an example of this disclosure, after polishing and shaping, the plant fiber cat litter particles undergo screening and dust removal. For the problem that a large amount of powder falls off the wrapped particles smaller than 8 mesh and larger than 5 mesh after drying, polishing, and shaping, a 10 mesh filter screen is used to repeatedly screen all the particles after polishing and shaping, storing all the particles smaller than 10 mesh, and the powder particles larger than 10 mesh are screened out and transported to the core pressing and granulating step. The ratio of dust content of the polished and shaped particles smaller than 10 mesh is controlled within 0.05%, resulting in a non-grain plant fiber cat litter product that is universally compatible with smart cat toilet grids.

To address the issue of cat litter granules causing clogging due to bridging on the lattice of the litter tray, the cat litter granules, after being coated and dried, undergo a polishing and shaping process. This process is designed to reduce the friction between cat litter granules, lower their adhesiveness, improve the sphericity of the cat litter granules and the smoothness of their surfaces, and increase the flow index of the cat litter granules. This reduces the probability of cat litter granule bridging to zero, allowing the unclumped clean cat litter to pass through the hollow grid of the smart cat toilet grid plate.

The following examples describe more specifically the subject matter disclosed in this disclosure. These examples are only for illustrative explanation, as various modifications and changes within the scope of this disclosure are obvious to those skilled in the art. Unless stated otherwise, all parts, percentages, and ratios reported in the following examples are based on weight, and all reagents used in the examples are commercially available or can be synthesized by conventional methods and can be used directly without further processing. Furthermore, all instruments used in the examples are commercially available.

### Examples 1-3

This example provides a cat litter, including
a core, including following components by mass parts: non-grain plant fibers (100 parts), clumping agents (0.6-12 parts), water-absorbing agents (0.6-12 parts), breeding improvement agents (0.13-2.23 parts), deodorizing agents (0.13-2.23 parts), and anti-mold agents (0.13-2.23 parts); and
a shell layer, including following components by mass parts: non-grain plant fibers (100 parts by mass), clumping agents (99.5-600 parts), water-absorbing agents (3.33-100 parts), breeding improvement agents (33.3-300 parts), deodorizing agents (3.33-100 parts), and anti-mold agents (0.66-20 parts);
where mass ratio of the shell layer to the core is 1:(4-5). Specific raw materials and mass ratios for Examples 1-3 are shown in Table 1.

This example provides a method for preparing cat litter, including following steps:
(1) Using a specialized plant fiber crushing equipment to crush the non-grain plant fiber raw materials of the cat litter core to a fineness of 200˜400 mesh;
(2) Using a specialized stirring and mixing equipment to uniformly mix the various non-grain plant fibers in proportion, with a rotational-speed for stirring of 0-850 r/min, and a time for stirring 0.5-3 minutes;
(3) Adding water to the non-grain plant fibers from step (2) according to the mass ratio mentioned above, stirring while adding water until the addition is complete, then continue stirring, with a rotational speed for stirring of 0-850 r/min, and a total time for stirring of 0.5-3 minutes, after which the mixture is set aside for later use;
(4) Using specialized stirring and mixing equipment to mix the clumping agents, water-absorbing agents, breeding improvement agents, deodorizing agents, and anti-molding agents materials uniformly according to the above-mentioned mass ratios, with a rotational speed for stirring of 0-1500 r/min, and a time for stirring of 0.5-3 minutes;
(5) Adding the mixture from (4) to the mixture of non-grain plant fibers and water from (3), stirring while adding, and after the materials from (4) are fully added, continue stirring, with a rotational speed for stirring of 0-850 r/min, and a total time for stirring of 0.5-5 minutes.
(6) Feeding the mixture from step (5) into specialized granulating equipment for continuous granulation. The granulation equipment uses a mold with a hole diameter of 2 mm-3.5 mm, a hole length of 8 mm-20 mm, a compression ratio of 1.5-9, and the mold holes have trumpet-shaped release ports with a vertical depth of 1 mm and a 60° angle between the trumpet surface tangent and the mold surface. The cutting blade of the granulation equipment is set horizontally, with a distance of 0.1-0.5 mm between the blade and the mold surface, to control the diameter of the core of the extruded cat litter particles between 2-3.5 mm, and the ratio of length to diameter is controlled at (1-3):1, with the granulation equipment working at a rotational speed of 800-1000 r/min.
(7) After the granulation of the cat litter core is completed, the granulated particles, along with any fragments and powder produced by the core pressing, are sieved using an 8-mesh screen. The sieved particles will then enter the wetting and coating process.
(8) Using specialized plant fiber crushing equipment to crush the non-grain plant fiber raw materials needed for the shell layer of the cat litter particles to a fineness of 80-100 mesh.
(9) Uniformly mixing the non-grain plant fibers from step (8), along with the clumping agents, water-absorbing agents, breeding improvement agents, deodorizing agents, and anti-molding agents, according to the mass ratios mentioned above using specialized stirring and mixing equipment at a rotational speed of 0-1500 r/min for 0.5-3 minutes.
(10) Wetting the intact particles obtained from the sieving in step (7), where the amount of water used is accounted for using the moisture content in the shell layer of the cat litter according to the first aspect of the present disclosure where the non-grain plant fiber in the cat litter has a particle size that passes through 80- to 100-mesh sieve. A spray treatment is used to wet the intermediate products of the core of the cat litter in a rotating equipment at a rotational speed of 30 60 r/min.
(11) Coating the wetted intermediate products of the core of the cat litter, where after the wetting process of step (10) is completed, the intermediate products are transferred to a specialized coating equipment. The coating equipment is started, and the cat litter shell layer material prepared by stirring and mixing according to the ratio according to the first aspect of the present disclosure from step (9) is rapidly added to the wetted intermediate products while rotating. In the cat litter according to the first aspect of the present disclosure, the non-grain plant fiber in the cat litter has a particle size that passes through 80- to 100-mesh sieve. The equipment rotates at a rotational speed of 30-60 r/min, with a total coating time of 2-6 minutes, and the thickness of the coated cat litter shell layer must reach more than 0.5 mm.
(12) For the large particles formed due to the wet wrapping process in step (11), after the coating is completed, using a 5-mesh filter screen to sieve all the coated particles, where particles smaller than 5 mesh sieved out are transferred to the core granulation stage, while particles larger than 5 mesh go through an 8-mesh filter screen for further sieving. Particles smaller than 8 mesh and larger than 5 mesh enter the drying process, and the fragments and powder larger than 8 mesh that are sieved out are transferred back to the core granulation stage.
(13) Drying particles smaller than 8 mesh and larger than 5 mesh at a temperature of 65-75° C., where the overall moisture content of the dried cat litter particles is controlled between 5-10%.
(14) After drying, entering the dry cat litter particles a specialized rotating polishing equipment for polishing and shaping, where the polishing equipment operates at a rotational speed of 30-60 r/min for a polishing duration of 15-30 minutes.
(15) After polishing and shaping, subjecting the plant fiber cat litter particles to sieving and dedusting, where considering the issue of a large amount of powder falling off the particles smaller than 8 mesh and larger than 5 mesh after drying and polishing, a 10-mesh filter screen is used for multiple sievings of all polished particles; where particles smaller than 10 mesh are all stored, while powder particles larger than 10 mesh are sieved out and transferred to the core granulation stage; where the ratio of dust content of the polished particles smaller than 10 mesh is controlled within 0.05%, resulting in cat litter that is universally compatible with intelligent cat litter grids.

Examples 1-3 are prepared according to parameters shown in Table 2.

### Comparative Example 1-2

The cat litter in this comparative example differs from that in Example 1 in terms of the components and preparation process as shown in Tables 1 and 2.

### Comparative Example 3

This comparative example provides a type of commercially available tofu cat litter, whose components include soybean residue making up 90% of the total mass of the tofu cat litter, with the remainder being clumping agents and anti-molding agents.

### Comparative Example 4

This comparative example's cat litter composition includes bentonite. Bentonite is quite heavy, requiring considerable effort to transport when stockpiling and changing the cat litter; secondly, bentonite cat litter produces a lot of dust, which can pose a hazard to cats' respiratory and urinary systems.

### Tests:

(1) Bulk Density Test: The mass of the sample that flows into a standard volume container through a specific size funnel is weighed, and the result is calculated.

Equipment: Bulk density measurement device.

TABLE 1

| | | | | | | | | Comparative | | Comparative | |
|---|---|---|---|---|---|---|---|---|---|---|---|
| | | Example 1 | | Example 2 | | Example 3 | | Example 1 | | Example 2 | |
| | | | Shell | | Shell | | Shell | | Shell | | Shell |
| Raw Materials and Components | | Core | Layer | Core | Layer | Core | Layer | Core | Layer | Core | Layer |
| Non-grain | Bamboo Fiber | 75 | | 35 | | | | | | | |
| Plant Fibers | Wood Fiber | | | 20 | | 75 | | 75 | | 75 | |
| | Sugarcane | | 15 | | 12 | | 10 | | 10 | | |
| | Bagasse Fiber | | | | | | | | | | |
| Water | | 45 | 50 | 40 | 45 | 30 | 40 | 30 | 40 | 30 | |
| Clumping | Pre-gelatinized | 0.5 | 15 | | | | | | | | |
| Agents | Starch | | | | | | | | | | |
| | Guar Gum | | | 3 | 23 | | | | | | |
| | Sodium | | | | | 5 | 30 | 5 | 30 | 5 | |
| | Carboxymethyl | | | | | | | | | | |
| | Cellulose | | | | | | | | | | |
| Water- | Polyvinyl Alcohol | 0.5 | 0.5 | | | | | | | | |
| absorbing | Polyacrylamide | | | 3 | 3 | | | | | | |
| agents | Sodium Polyacrylate | | | | | 5 | 5 | 5 | 5 | 5 | |
| breeding | Sodium | 0.1 | 5 | | | | | | | | |
| improvement | Aluminosilicate | | | | | | | | | | |
| agents | Hydrate | | | | | | | | | | |
| | Attapulgite | | | 0.5 | 10 | | | | | | |
| | High Purity Nano- | | | | | 1 | 15 | 1 | 15 | 1 | |
| | modified | | | | | | | | | | |
| | Montmorillonite | | | | | | | | | | |
| deodorizing | Nano Titanium | 0.1 | 0.5 | | | | | | | | |
| agents | Dioxide | | | | | | | | | | |
| | Allophane | | | 0.5 | 3 | | | | | | |
| | hydrophilic | | | | | 0.6 | 3 | 0.6 | 3 | 0.6 | |
| | modified ultrafine | | | | | | | | | | |
| | silica | | | | | | | | | | |
| | Baking Soda | | | | | 0.3 | 1.5 | 0.3 | 1.5 | 0.3 | |
| anti-mold | Copper-loaded | | | | | | | | | | |
| agents | Phosphate | | | | | | | | | | |
| | antibacterial | | | | | | | | | | |
| | powder | | | | | | | | | | |
| | Silver-loaded | 0.5 | | 0.5 | 0.5 | | | | | | |
| | zirconium phosphate | | | | | | | | | | |
| | antibacterial powder | | | | | | | | | | |
| | 5-Chloro-2-methyl- | | 1 | | | 1 | 1 | | | 1 | |
| | 4-isothiazolin-3-one | | | | | | | | | | |
| Shell-to- | | 1:4.5 | | 1:4 | | 1:5 | | 1:4.5 | | Only | |
| Core Mass | | | | | | | | | | cores | |
| Ratio | | | | | | | | | | | |

TABLE 2

| | Example | Example | Example | Comparative | Comparative |
|---|---|---|---|---|---|
| Process Conditions | 1 | 2 | 3 | Example 1 | Example 2 |
| Plant Fiber Fineness of Raw Material | 200 | 300 | 400 | 400 | 400 |
| (mesh) | | | | | |
| Moisture Content Control of | 40 | 35 | 30 | 30 | 30 |
| Intermediate Product in the Core (%) | | | | | |
| Granulation Equipment Die Hole | 3 | 2.5 | 2 | 2 | 2 |
| Diameter (mm) | | | | | |
| Die Hole Length (mm) | 12 | 10 | 8 | 8 | 8 |
| Die Compression Ratio | 4 | 4 | 4 | 4 | 4 |
| Distance between Cutting Blade and | 0.5 | 0.3 | 0.1 | 0.1 | 0.1 |
| Lower Surface of Die (mm) | | | | | |
| 8-mesh Filter Screen after Core | Yes | Yes | Yes | No | Yes |
| Compression (Yes/No) | | | | | |
| Plant Fiber Fineness of Shell Layer | 80 | 90 | 100 | 100 | None |
| (mesh) | | | | | |
| Control of Undried Shell Layer | 45 | 40 | 35 | 35 | None |
| Moisture Content (%) | | | | | |
| Wrapper Equipment Rotation Speed | 55 | 45 | 35 | 35 | None |
| (r/min) | | | | | |
| Wrapper Time (min) | 3 | 4 | 5 | 5 | None |
| Wrapper Shell Layer Thickness (mm) | 0.6 | 0.7 | 0.8 | 0.8 | None |
| 5-mesh and 8-mesh Filter Screens after | Yes | Yes | Yes | No | None |
| Wrapping (Yes/No) | | | | | |
| Overall Moisture Content Control of | 40 | 35 | 30 | 30 | None |
| Granules after Wrapping (pre-drying) | | | | | |
| (%) | | | | | |
| Drying Temperature (° C.) | 75 | 70 | 65 | 65 | 65 |
| Moisture Content Control of Finished | 10 | 8 | 6 | 6 | 6 |
| Granules after Drying (%) | | | | | |
| Polishing Equipment Rotation Speed | 35 | 45 | 55 | / | 55 |
| (r/min) | | | | | |
| Polishing Time (min) | 15 | 20 | 25 | / | 25 |
| 10-mesh Filter Screen after Polishing | Yes | Yes | Yes | / | Yes |
| (Yes/No) | | | | | |

Steps: The cat litter sample is poured into a funnel above a closed baffle. Once the sample is level with the funnel mouth, the baffle is removed, and the cat litter flows naturally into the container below. Excess material on top of the container is scraped off, and the sample in the container is weighed.

Calculation: The bulk density p is expressed in g/L and calculated as p=m/v×100%, where m is the mass of the sample in grams (g) and v is the volume of the container in milliliters (mL).

(2) Moisture Content Detection: The instrument uses program-controlled heating with a halogen/infrared lamp to heat the sample, automatically weighing it continuously until a constant mass is reached and then reporting the result.

Equipment: Rapid moisture meter with halogen/infrared lamp heating, sensitivity specification of 0.001 g.

Steps of analysis: About 2 g of the cat litter sample is spread on the drying pan of the rapid moisture meter, set the drying temperature control at 105° C. The measuring program is started, and the rapid moisture meter stops after 10 minutes of measurement.

(3) Test of Flowability Index Fw: Measured according to Part 3 of the standard GB/T 31057.3-2018: Measuring of Flowability index.

(4) Dust Content Detection: A certain amount of cat litter sample is sieved, and the proportion of material that passes through a 30-mesh sieve is observed.

Equipment: Metal wire woven mesh test sieve according to GB/T6003.1-2012 series test sieves, standard sieve shaker.

Note 1: The test sieve mesh size is 30 mesh 500 μm, sieve frame diameter 200 mm.

Note 2: The standard sieve shaker specification has a vibration frequency of 1440 times/minute.

Steps of Analysis: Randomly extract 500 g (m²) of finished cat litter in 5 portions of 100 g each, pour into a 30-mesh standard sieve, place in the sieve shaker, cover with a sealing cover, start the shaker and vibrate for 15 seconds. After sieving, collect and weigh the powder from all 5 portions, tallying and weighing to obtain mp.

Calculation: The dust content rate F is calculated as F=mp/m2×100%, where F is the dust content rate (%), m² is the total sample mass in grams (g), and mp is the total mass of the powder that has passed through the sieve in grams (g).

(5) Clumping Weight Detection: The weight of the cat litter after it absorbs water and clumps together.

(6) Clumping Strength Detection: The clumped plant fiber cat litter is dropped from a certain height onto a marble or other inelastic surface, and the largest unbroken clump of plant fiber cat litter is picked up and weighed. The mass ratio of the largest unbroken clump to the pre-drop litter clump is the clumping strength.

(7) Water Absorption Rate Detection: After the sample absorbs water and clumps together, its weight is measured.

Equipment for this step includes:
a) A balance with a sensitivity specification of 0.01 g;
b) An acid burette with a specification of 25 mL;
c) A pipette with a specification of 20 mL.

Steps: Spread the cat litter sample in the sample tray to a thickness of about 8 cm-10 cm, use the pipette to draw 20 mL of 1% sodium chloride solution at a temperature of 36° C.-40° C., transfer to the acid burette, adjust the burette about 3 cm above the sample surface, open the burette, let the solution flow into the sample within 30 seconds, after 60 seconds of complete outflow, take out the clumped sample and weigh it on the balance with a sensitivity of 0.01 g, obtaining a mass m Perform this method in triplicate and take the average weight, calculate the water absorption rate with the formula:

X=20/(m−20)*100%

where X is water absorption rate, m is weight of clumps by grams.

(8) Clumping Mold Detection: The content of coliforms is measured according to GB/T18869, the content of Salmonella according to GB/T13091, the total mold count according to GB/T13092, and the content of aflatoxin B1 according to GB/T17480.

(9) Sphericity Detection Method:

Through image processing, the measuring software automatically counts the number of particles, calculates the number of pixels in each particle, and obtains parameters such as area, equivalent diameter, equivalent perimeter, actual perimeter, roundness, etc., to determine the particle shape. Morphological parameters of particles measured by the graphic image analyzer mainly include aspect ratio and roundness coefficient. Aspect ratio refers to the ratio of the length to the diameter of a cylindrical object. The calculation result of sphericity is between 0 and 1. The smaller the value, the more irregular the shape of the particles.

Table 3 below outlines the detection and measurement results.

TABLE 3
( *: Comparative Example 3 is commercially available Tofu cat litter)

| | | | | Com- | Com- | Com- | Com- |
|---|---|---|---|---|---|---|---|
| Performance | Example | | Example | parative | parative | parative | parative |
| Indicators | 1 | Example 2 | 3 | Example 1 | Example | Example 3* | Example 4 |
| Granule | 3.5-4 | 3-3.5 | 2.5-3 | 2.5-12 | 2-2.5 | 2-3 | 1.6-4.2 |
| Diameter | | | | | | | |
| of Cat | | | | | | | |
| Litter | | | | | | | |
| Product | | | | | | | |
| (mm) | | | | | | | |
| Granule | 3.5-12 | 3-10.5 | 2.5-9 | 2.5-12 | 2-7.5 | 10-25 | 1.9-4.5 |
| Length of | | | | | | | |
| Cat Litter | | | | | | | |
| Product | | | | | | | |
| (mm) | | | | | | | |
| Bulk | 320 | 340 | 360 | 375 | 390 | 580 | 990 |
| Density of | | | | | | | |
| Cat Litter | | | | | | | |
| Product | | | | | | | |
| (g/L) | | | | | | | |
| Sphericity | Particles | Particles | Particles | Particles | Particles | Particles | Particles |
| (Roundness | with a | with a | with a | with a | with a | with a | with a |
| Value | roundness | roundness | roundness | roundness | roundness | roundness | roundness |
| and | value | value | value | value | value | value | value |
| Distribution | greater | greater | greater | greater | greater | greater than | greater |
| Ratio) | than 0.7 | than 0.7 | than 0.7 | than 0.7 | than 0.7 | 0.7 | than 0.7 |
| | constitute | constitute | constitute | constitute | constitute | constitute | constitute |
| | 88% of | 92% of the | 95% of | 86% of | 92% of | 75% of the | 97% of |
| | the total; | total; | the total; | the total; | the total; | total; | the total; |
| | particles | particles | particles | particles | particles | particles | particles |
| | with a | with a | with a | with a | with a | with a | with a |
| | roundness | roundness | roundness | roundness | roundness | roundness | roundness |
| | value | value less | value less | value less | value less | value less | value less |
| | less than | than 0.3 | than 0.3 | than 0.3 | than 0.3 | than 0.3 | than 0.3 |
| | 0.3 | constitute | constitute | constitute | constitute | constitute | constitute |
| | constitute | 1% | 0.5% | 2% | 0.5% | 5% | 0.3% |
| | 1.5% | | | | | | |
| Flowability | 88 | 91 | 94 | 78 | 91 | 64 | 97 |
| Index | | | | | | | |
| Fw | | | | | | | |
| Dust | 0.04 | 0.03 | 0.03 | 0.4 | 0.3 | 0.5 | 0.6 |
| Content | | | | | | | |
| Clumping | 28 | 28 | 29 | 28 | >120 | 47 | 66 |
| Weight | | | | | | | |
| (g/20 g | | | | | | | |
| Water) | | | | | | | |
| Clumping | 94 | 96 | 97 | 89 | 0 | 93 | 93 |
| Strength | | | | | | | |
| (%) | | | | | | | |
| Absorption | 250 | 250 | 222 | 250 | <20 | 74 | 44 |
| rate (%) | | | | | | | |
| Days to | >30 | >30 | >30 | 6 | >30 | 6 | >15 |
| Initial Mold | | | | | | | |
| Growth of | | | | | | | |
| Clumps | | | | | | | |

In summary, compared to the comparative examples, examples of the cat litter in this disclosure has better flowability, is less prone to mold, has a better water absorption rate, contains less dust content, and is more suitable for cats to use.

According to some examples, the cat litter satisfies at least one of following conditions:
a moisture content of the cat litter is 5%-10%;
the cat litter is configured to be sifted through a 10-mesh screen;
a ration of dust of the cat litter is at most 0.05%;
a bulk density of the cat litter is 280-400 g/L;
the cat litter is in a rod-shape, and the core is in the rod-shape; where the rod-shape has a diameter of 2-3.5 mm and a length-to-diameter ratio of (1-3):1; or
a thickness of the shell layer is 0.5-3 mm.

According to some examples, the non-grain plant fibers include one or more of following fibers: sugarcane bagasse fiber, bamboo fiber, corn core fiber, eucalyptus fiber, giant fungus grass fiber, straw fiber, eulaliopsis binata fiber (dragon whisker grass fiber), or bamboo shell fiber.

According to some examples, a non-grain plant fiber in the cat litter has a particle size that passes through 80- to 100-mesh sieve.

According to some examples, the clumping agents include one or more of following agents: whey protein, sodium alginate, corn protein, montmorillonite, carboxymethyl cellulose and derivatives, guar gum, native starch, pre-gelatinized starch, or gelatin.

According to some examples, the water-absorbing agents include one or more of following agents: polyacrylate, starch-acrylate polymer, starch-acrylonitrile graft copolymer, acrylamide-acrylonitrile-acrylic acid terpolymer, polyacrylamide and its derivatives, or polyvinyl alcohol.

According to some examples, the breeding improvement agents include one or more of following agents: attapulgite, polyacrylamide-attapulgite composite adsorbent, high-purity nanomodified montmorillonite, plant essential oils, hydrated sodium calcium aluminosilicate, diatomaceous earth, or zeolite.

According to some examples, the deodorizing agents include one or more of following agents: allophane, hydrophilic modified ultrafine silica, baking soda, nano zinc oxide, or nano titanium dioxide.

According to some examples, the anti-mold agents include one or more of following agents: esterified glucomannan, hydrated sodium calcium aluminosilicate, silver-loaded zirconium phosphate antibacterial powder, copper-loaded phosphate antibacterial powder, organic zinc ion antibacterial powder, 5-chloro-2-methyl-4-isothiazolin-3-one, 1,2-benzisothiazolin-3-one, 4,5-dichloro-2-octyl-3-isothiazolone, 2-methyl-4-isothiazolin-3-one, or N-octyl-4-isothiazolin-3-one.

Beneficial effects of this disclosure at least include:

The cat litter provided in this disclosure includes a core and a shell layer, respectively containing non-grain plant fibers, clumping agents, water-absorbing agents, breeding improvement agents, deodorizing agents, and mold prevention agents. The synergistic effect of these components enhances the clumping and moisture absorption of the cat litter. It achieves efficient clumping of urine and envelopment of feces, allowing for easy separation from clean, unused litter, thus preventing waste. Furthermore, the clumping portions of cat excrement are less likely to produce odors and mold. Additionally, using non-grain plant fibers as the main material gives the cat litter good water solubility, so the used clumps can be directly flushed down the toilet.

The cat litter proposed in this disclosure includes a core and a shell layer, both containing non-grain plant fibers. Compared to bentonite cat litter, tofu/bentonite mixed cat litter, and tofu cat litter, this cat litter is lightweight and has a low specific gravity, which facilitates storage, handling, and replacement.

The cat litter of this disclosure utilizes a shell layer that wraps around the core. The mass ratio of the core and shell layer is within an appropriate range, which benefits the clumping performance and reduces the dust rate. It also facilitates the absorption of moisture and the clumping of feces. In combination with the related process, it strictly controls the dust content of the plant fiber cat litter. When compared to bentonite cat litter, tofu/bentonite mixed cat litter, and tofu cat litter, the cat litter provided in the disclosure exhibits ultra-low dust characteristics, which is beneficial for the respiratory health of pets and owners.

The specifics mentioned above are only the concrete examples of this disclosure, but the scope of protection of this disclosure is not limited to these. Any person skilled in the technical field can easily think of various equivalent modifications or substitutions within the technical scope disclosed in this disclosure, and these modifications or replacements should be encompassed within the scope of protection of the disclosure. Therefore, the scope of protection of the disclosure should be determined by the scope of the claims.

What is claimed is:

1. A cat litter having a core-shell structure, comprising:
a core, comprising components by mass parts comprising: non-grain plant fibers in 100 parts, clumping agents in a range of 0.6-12 parts, water-absorbing agents in a range of 0.6-12 parts, breeding improvement agents in a range of 0.13-2.23 parts, deodorizing agents in a range of 0.13-2.23 parts, and anti-mold agents in a range of 0.13-2.23 parts; and
a shell layer, comprising components by mass parts comprising: non-grain plant fibers in 100 parts, clumping agents in a range of 99.5-600 parts, water-absorbing agents in a range of 3.33-100 parts, breeding improvement agents in a range of 33.3-300 parts, deodorizing agents in a range of 3.33-100 parts, and anti-mold agents in a range of 0.66-20 parts;
wherein a mass ratio of the shell layer to the core is in a range of 1:(4-5).

2. The cat litter of claim 1, wherein the cat litter meets at least one of following conditions:
a moisture content of the cat litter is in a range of 5%-10%;
the cat litter is configured to be sifted through a 10-mesh screen;
a ratio of dust of the cat litter is no greater than 0.05%;
a bulk density of the cat litter is in a range of 280-400 g/L;
the cat litter is in a rod-shape, and the core is in the rod-shape; wherein the rod-shape has a diameter of 2-3.5 mm and a length-to-diameter ratio of (1-3):1; or
a thickness of the shell layer is in a range of 0.5-3 mm.

3. The cat litter of claim 1, wherein the non-grain plant fibers comprise one or more of following fibers: sugarcane bagasse fiber, bamboo fiber, corn core fiber, eucalyptus fiber, giant fungus grass fiber, straw fiber, eulaliopsis binata fiber, or bamboo shell fiber.

4. The cat litter of claim 1, wherein a non-grain plant fiber in the cat litter has a particle size that passes through 80- to 100-mesh sieve.

5. The cat litter of claim 1, wherein the clumping agents comprise one or more of following agents: whey protein, sodium alginate, corn protein, Montmorillonite, carboxymethyl cellulose and derivatives, guar gum, native starch, pre-gelatinized starch, or gelatin.

6. The cat litter of claim 1, wherein the water-absorbing agents comprise one or more of following agents: polyacrylate, starch-acrylate polymer, starch-acrylonitrile graft copolymer, acrylamide-acrylonitrile-acrylic acid terpolymer, polyacrylamide and its derivatives, or polyvinyl alcohol.

7. The cat litter of claim 1, wherein the breeding improvement agents comprise one or more of following agents: attapulgite, polyacrylamide-attapulgite composite adsorbent, high-purity nanomodified montmorillonite, plant essential oils, hydrated sodium calcium aluminosilicate, diatomaceous earth, or zeolite.

8. The cat litter of claim 1, wherein the deodorizing agents comprise one or more of following agents: allophane, hydrophilic modified ultrafine silica, baking soda, nano zinc oxide, or nano titanium dioxide.

9. The cat litter of claim 1, wherein the anti-mold agents comprise one or more of following agents: esterified glucomannan, hydrated sodium calcium aluminosilicate, silver-loaded zirconium phosphate antibacterial powder, copper-loaded phosphate antibacterial powder, organic zinc ion antibacterial powder, 5-chloro-2-methyl-4-isothiazolin-3-one, 1,2-benzisothiazolin-3-one, 4,5-dichloro-2-octyl-3-isothiazolone, 2-methyl-4-isothiazolin-3-one, or N-octyl-4-isothiazolin-3-one.

10. A method for preparing a cat litter, comprising:
providing a first raw material for a core of the cat litter, wherein the first raw material comprises components by mass parts comprising: water in a range of 120-1000 parts, non-grain plant fibers in 100 parts, clumping agents in a range of 0.6-12 parts, water-absorbing agents in a range of 0.6-12 parts, breeding improvement agents in a range of 0.13-2.23 parts, deodorizing agents in a range of 0.13-2.23 parts, and anti-mold agents in a range of 0.13-2.23 parts;
providing a second raw material for a shell layer comprising components by mass parts comprising: non-grain plant fibers in 100 parts, clumping agents in a range of 99.5-600 parts, water-absorbing agents in a range of 3.33-100 parts, breeding improvement agents in a range of 33.3-300 parts, deodorizing agents in a range of 3.33-100 parts, and anti-mold agents in a range of 0.66-20 parts, and water in a range of 133-1000 parts;
mixing and first stirring the first raw material to obtain a first mixture;
granulating and first sieving the first mixture to obtain an intermediate product of the core;
mixing and second stirring the second raw material to obtain a shell layer mixture;
wetting the intermediate product of the core, and wrapping the intermediate product of the core with the shell layer mixture to obtain a coated mixture; and
successively second sieving, drying, and third sieving the coated mixture to obtain the cat litter.

11. The method of claim 10, wherein the method meets at least one of following conditions:
a rotational speed for the first stirring is in a range of 5-850 r/min, and a duration for the first stirring is in a range of 0.5-5 minutes;
a rotational speed for granulating is in a range of 800-1000 r/min;
a rotational speed for the second stirring is in a range of 0-1500 r/min, and a duration for the second stirring is in a range of 0.5-3 minutes;
a moisture content of the intermediate product of the core is within 45%.

12. The method of claim 11, wherein the intermediate product of the core is rod-shaped, a diameter of the intermediate product of the core is in a range of 2-3.5 mm, and a length-to-diameter ratio of the intermediate product of the core is in a range of (1-3):1;
a moisture content of the shell layer mixture is within 50%;
a rotational speed of equipment during coating is in a range of 30˜60 r/min, and a duration for coating is in a range of 2˜6 minutes;
a moisture content of the coated mixture is within 45%;
a granular diameter m of a product after the second sieving is:5 mesh <m<8 mesh;
a granular diameter n of a product after the third sieving is:8 mesh <n<12 mesh;
a temperature for drying is 65-75° C.; or
after drying, the method further comprises polishing and shaping a dried product, wherein a rotational speed for polishing in a range of is 30-60 r/min, and a duration for polishing is in a range of 15-30 minutes.

13. The method of claim 11, wherein the cat litter meets at least one of following conditions:
a moisture content of the cat litter is in a range of 5%-10%;
the cat litter is configured to be sifted through a 10-mesh screen;
a ratio of dust of the cat litter is no greater than 0.05%;
a bulk density of the cat litter is in a range of 280-400 g/L;
the cat litter is in a rod-shape, and the core is in the rod-shape; wherein the rod-shape has a diameter of 2-3.5 mm and a length-to-diameter ratio of (1-3):1; or
a thickness of the shell layer is in a range of 0.5-3 mm.

14. The method of claim 11, wherein the non-grain plant fibers comprise one or more of following fibers: sugarcane bagasse fiber, bamboo fiber, corn core fiber, eucalyptus fiber, giant fungus grass fiber, straw fiber, eulaliopsis binata fiber, or bamboo shell fiber.

15. The method of claim 11, wherein a non-grain plant fiber in the cat litter has a particle size that passes through 80- to 100-mesh sieve.

16. The method of claim 11, wherein the clumping agents comprise one or more of following agents: whey protein, sodium alginate, corn protein, montmorillonite, carboxymethyl cellulose and derivatives, guar gum, native starch, pre-gelatinized starch, or gelatin.

17. The method of claim 11, wherein the water-absorbing agents comprise one or more of following agents: polyacrylate, starch-acrylate polymer, starch-acrylonitrile graft copolymer, acrylamide-acrylonitrile-acrylic acid terpolymer, polyacrylamide and its derivatives, or polyvinyl alcohol.

18. The method of claim 11, wherein the breeding improvement agents comprise one or more of following agents: attapulgite, polyacrylamide-attapulgite composite adsorbent, high-purity nanomodified montmorillonite, plant essential oils, hydrated sodium calcium aluminosilicate, diatomaceous earth, or zeolite.

19. The method of claim 11, wherein the deodorizing agents comprise one or more of following agents: allophane, hydrophilic modified ultrafine silica, baking soda, nano zinc oxide, or nano titanium dioxide.

20. The method of claim 11, wherein the anti-mold agents comprise one or more of following agents: esterified glucomannan, hydrated sodium calcium aluminosilicate, silver-loaded zirconium phosphate antibacterial powder, copper-loaded phosphate antibacterial powder, organic zinc ion antibacterial powder, 5-chloro-2-methyl-4-isothiazolin-3-one, 1,2-benzisothiazolin-3-one, 4,5-dichloro-2-octyl-3-isothiazolone, 2-methyl-4-isothiazolin-3-one, or N-octyl-4-isothiazolin-3-one.
